(19) United States
(12) Patent Application Publication
(10) Pub. No.: US 2013/0321547 A1
(43) Pub. Date: Dec. 5, 2013

(54) INKJET PRINTER

(71) Applicant: HON HAI PRECISION INDUSTRY CO., LTD., New Taipei (TW)

(72) Inventors: KUNG-HUANG TSAI, New Taipei (TW); SHU-YA CHIANG, New Taipei (TW)

(73) Assignee: HON HAI PRECISION INDUSTRY CO., LTD., New Taipei (TW)

(21) Appl. No.: 13/892,400

(22) Filed: May 13, 2013

(30) Foreign Application Priority Data
Jun. 5, 2012 (TW) 101120189

(51) Int. Cl. B41J 11/00

(52) U.S. Cl. CPC B41J 11/0005
USPC 347/104

(57) ABSTRACT

An inkjet printer includes a platform for a print medium, a print-head carriage, and an airflow controller. The print-head carriage defines a plurality of air channels, each of which has an air intake and an air outtake. The air outtake is located on a bottom surface of the print-head carriage and faces the platform and during any movement of the print-head carriage blows airflow towards the print medium, forcing the print medium flat against the platform and thus to the optimal distance for the delivery of ink droplets.

### REFERENCE TO RELATED APPLICATIONS

This application claims all benefits accruing under 35 U.S.C. §119 from Taiwan Patent Application No. 101120189, filed on Jun. 5, 2012 in the Taiwan Intellectual Property Office, the contents of the Taiwan Application are hereby incorporated by reference.

### BACKGROUND

1. Technical Field

The present disclosure generally relates to image formation devices, and particularly relates to inkjet printers.

2. Description of Related Art

In an inkjet printer, one or more print heads are used to propel droplets of ink onto a print medium to create an image. However, if the print medium is not perfectly flat or has folds, the print heads may touch or damage the print medium, and the printed image will be blurred, due to the short distance between the print heads and the print medium.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of an inkjet printer.

FIG. 2 is an exploded view of the inkjet printer of FIG. 1.

FIG. 3 is a cutaway view of a print-head carriage of the inkjet printer of FIG. 1.

FIG. 4 is a cutaway view of a second airflow splitter of the inkjet printer of FIG. 1.

FIG. 5 is an isometric view of an air pusher of the inkjet printer of FIG. 1.

FIG. 6 is an exploded view of an air channel selector of the inkjet printer of FIG. 1.

FIG. 7 is a cutaway view of a tube fixing member of the inkjet printer of FIG. 1.

FIG. 8 is a top view of the inkjet printer of FIG. 1, showing an open air valve is.

FIG. 9 is a top view of the inkjet printer of FIG. 1, showing the print-head carriage moving in a first direction.

FIG. 10 is a top view of the inkjet printer of FIG. 1, showing the print-head carriage moving in a second direction.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

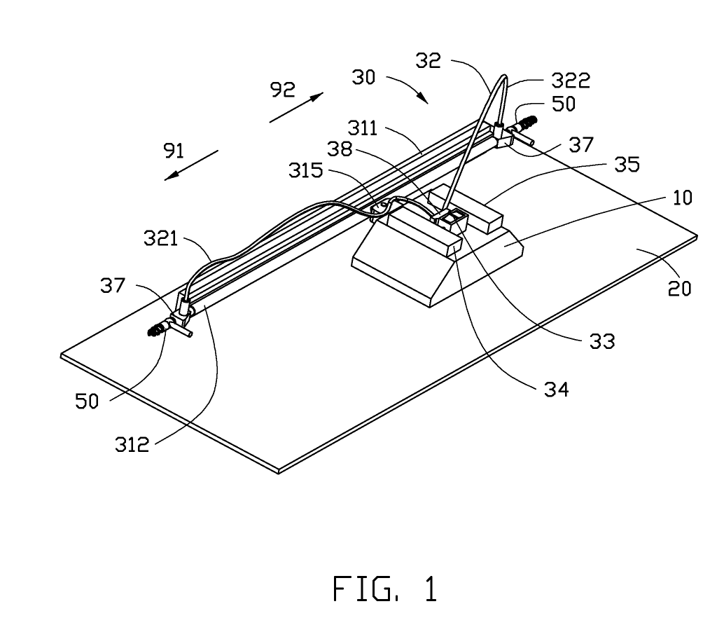

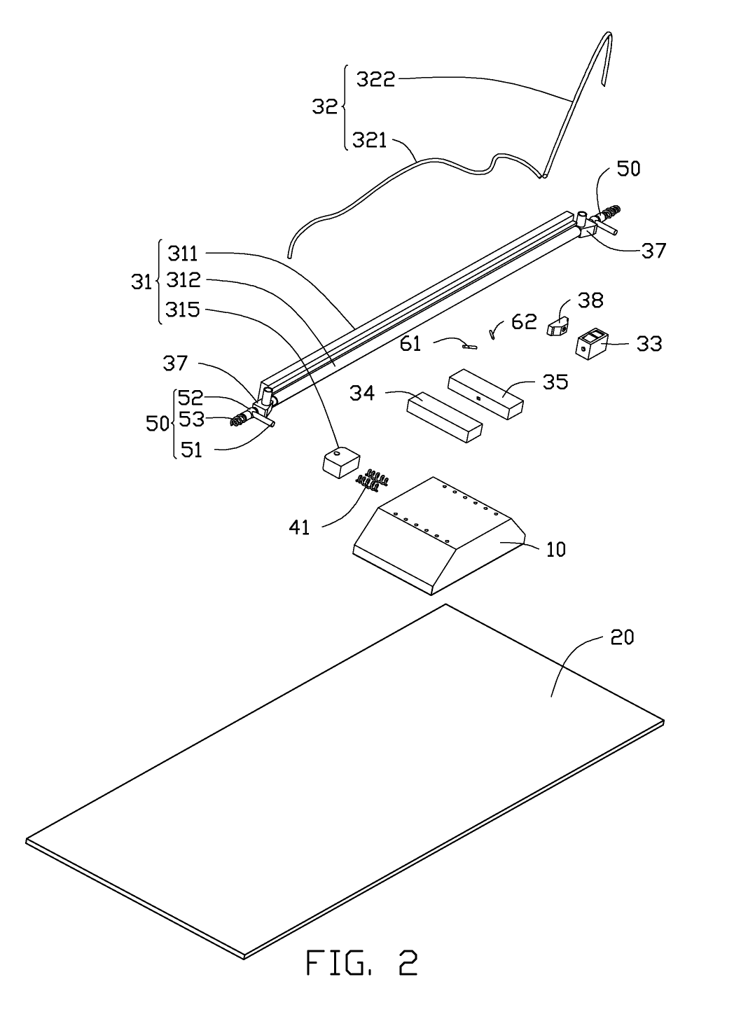

FIGS. 1 and 2 show an embodiment of an inkjet printer. The inkjet printer includes a print-head carriage 10, a platform 20, and an airflow controller 30. The print-head carriage 10 is located above the platform 20. Print heads (not shown) are supported by and located in the print-head carriage 20. A print medium, e.g. a sheet of paper, can be placed on the platform 20. The print-head carriage 10 can move in a first direction 91 (e.g., to the left) or a second direction 92 (e.g., to the right) to bring the print heads to various locations. The print heads can then propel droplets of ink onto the print medium placed on the platform 20 to create an image.

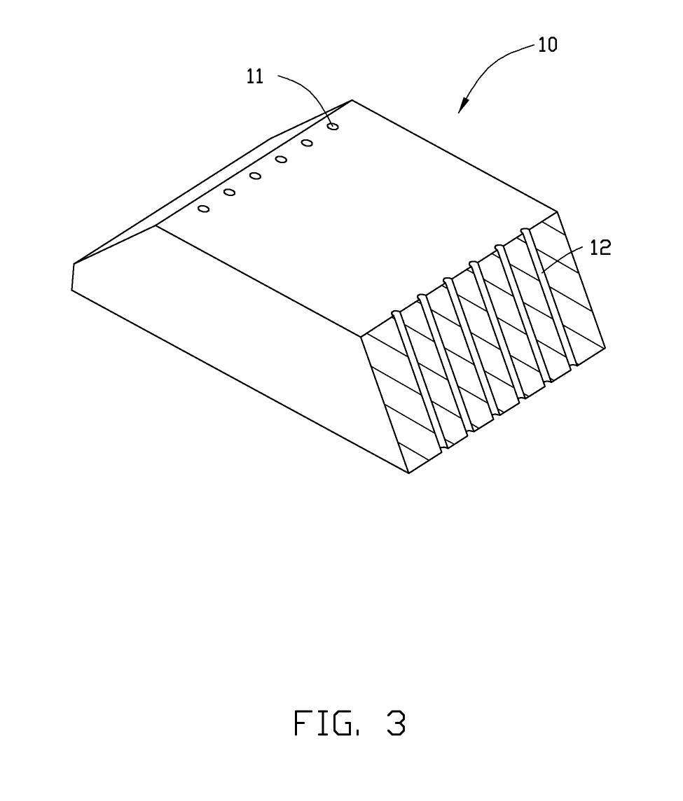

Referring to FIG. 3, the print-head carriage 10 defines a first group of air channels 11 and a second group of air channels 12. The first group of air channels 11 and the second group of air channels 12 each includes a plurality of air channels. Each air channel defines an air intake and an air outtake. The air intake is located on the bottom surface of the print-head carriage 10 and faces the platform 20. The air outtake is located on the top surface of the print-head carriage 10. The first group of air channels 11 is located in the left side of the print-head carriage 10. The second group of air channels 12 is located in the right side of the print-head carriage 10.

The airflow controller 30 generates airflow and selectively directs the airflow into the first group of air channels 11 and into the second group of air channels 12. The airflow controller 30 includes an airflow generator 31, an airflow guiding member 32, an air channel selector 33, a first airflow splitter 34, and a second airflow splitter 35. The airflow generator 31 generates airflow. The airflow guiding member 32 introduces the airflow generated by the airflow generator 31 to the air channel selector 33. The air channel selector 33 selectively introduces the airflow to the first airflow splitter 34 and the second airflow splitter 35. The first airflow splitter 34 may split the airflow into derivative airflow and introduce the derivative airflow into the first group of air channels 11. The second airflow splitter 35 may split the airflow into derivative airflow and introduce the derivative airflow into the second group of air channels 12.

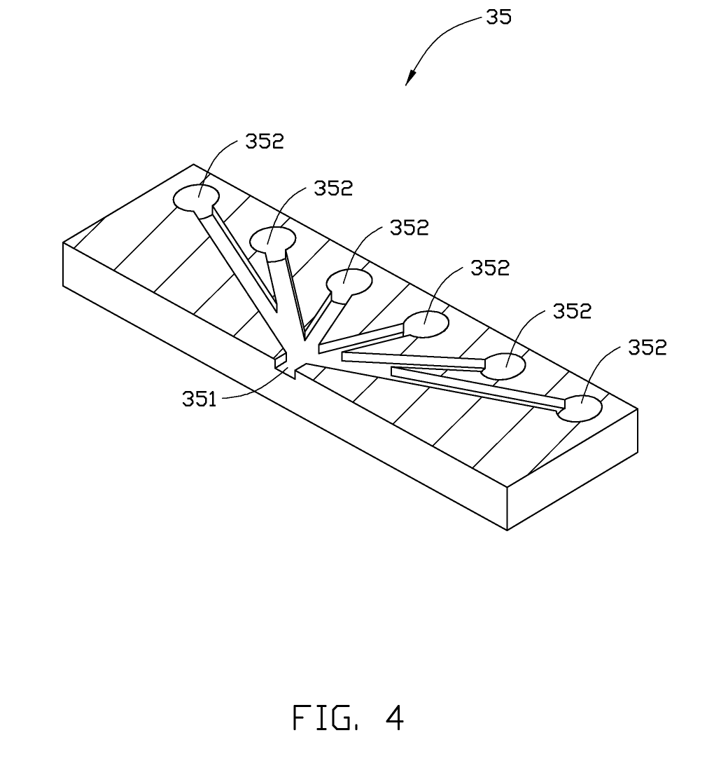

Referring to FIG. 4, the second airflow splitter 35 defines an air input opening 351 and a plurality of air output openings 352. The second airflow splitter 35 can receive airflow through the air input opening 351 and split the airflow into derivative airflow and then blow out the derivative airflow through the plurality of air output openings 352. The plurality of air output openings 352 communicates with the second group of air channels 12. Thus, the second airflow splitter 35 can introduce the derivative airflow into the second group of air channels 12. The structures of the first airflow splitter 34 and of the second airflow splitters 35 are substantially identical.

The airflow generator 31 includes a blocking plate 311, a deformable air tube 312, and an air pusher 315. The air tube 312 is a hollow flexible tube which can store air inside. The air pusher 315 can move relative to the air tube 312. When the air pusher 315 presses the air tube 312 and moves along the air tube 312, the air pusher 315 squeezes and deforms the air tube 312 thus extrudes air inside the air tube 312 to generate airflow. The extending direction of the air tube 312 is substantially parallel to the movement direction of the print-head carriage 10. In other words, two ends of the air tube 312 respectively extend in the first direction 91 and the second direction 92.

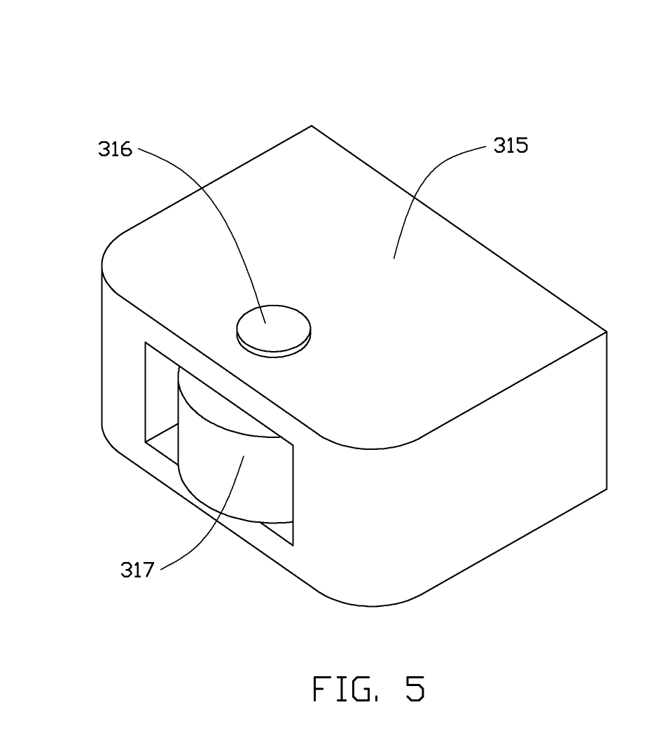

Referring to FIG. 5, the air pusher 315 includes a pushing roller 317. The pushing roller 317 squeezes the air tube 312, and is rotatable about an axis 316. The pushing roller 317 can reduce the friction force between the air pusher 315 and the air tube 312 when the air pusher 315 is moved along the air tube 312. The air pusher 315 is attached to the print-head carriage 10. The air pusher 315 moves together with the print-head 10 whether the print-head carriage 10 moves in the first direction 91 or in the second direction 92.

The inkjet printer further includes a first resilient member 41 located between the air pusher 315 and the print-head carriage 10. One end of the first resilient member 41 is connected to the air pusher 315 and the other end of the first resilient member 41 is connected to the print-head carriage 10. The first resilient member 41 exerts an elastic force to push the air pusher 315 to press the air tube 312. In one embodiment, the first resilient member 41 is a compression spring.

The inkjet printer further includes two air valves 50 located at two openings of the air tube 312. When the air pusher 315 is located between the two openings of the air tube 312, the two air valves 50 block the two openings of the air tube 312. When the pusher 315 is moved to an opening of the air tube 312, the air valve 50 located at the opening of the air tube 312 opens and no longer blocks the opening of the air tube 312, so the air can enter the air tube 312 through the opening of the air tube 312.

The air valve 50 includes a valve stick 51, an air spigot 52, and a second resilient member 53. The air spigot 52 is attached to an end of the valve stick 51. The valve stick 51 is adapted to drive the air spigot 52 to move away from or towards the opening of the air tube 312. The second resilient member 53 produces an elastic force urging the air spigot 52 to block the opening of the air tube 312. In one embodiment, the second resilient member 53 is a compression spring. The valve stick 51 is substantially perpendicular to the extending direction of the air tube 312.

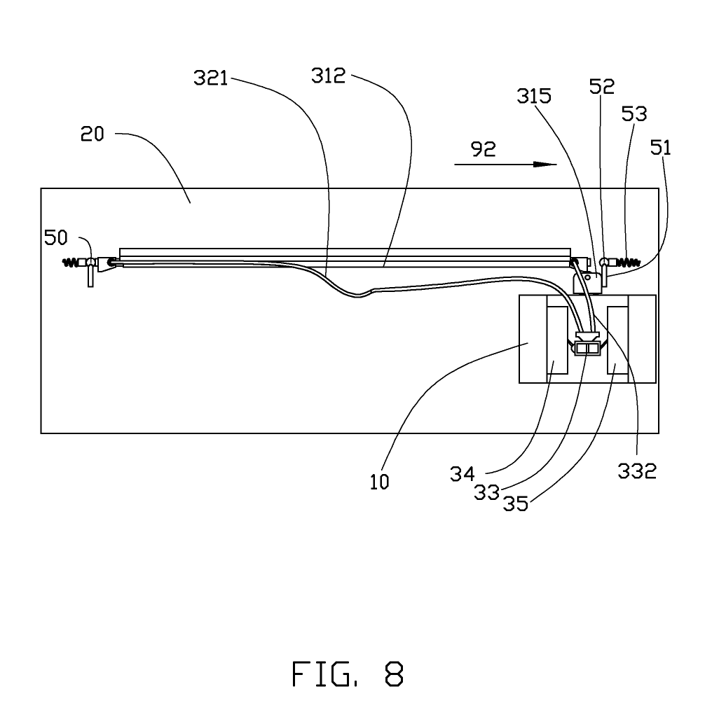

Referring to FIG. 8, when the air pusher 315 moves to the right opening of the air tube 312, the air pusher 315 pushes the valve stick 51 to move away from the right opening of air tube 312. Thus, the air can enter the air tube 312 through the right opening of the air tube 312. In FIG. 1, when the air pusher 315 is located between the two openings of the air tube 312, the two air spigots 52 are pushed by the two second resilient members 53 to block the two openings of the air tube 312.

A sloping guide rail 37 is located at each of the two openings of the air tube 312. As shown in FIG. 8, when the air pusher 315 moves in the second direction 92 and reaches the sloping guide rail 37, the air pusher 315 is raised by the sloping guide rail 37 away from the air tube 312, so that the air pusher 315 no longer squeezes the air tube 312. When the air pusher 315 continues moving in the second direction 92, the air pusher 315 pushes the valve stick 51 to drive the air spigot 52 to move away from the right opening of the air tube 312 so that the air can enter the air tube 312 through the right opening of the air tube 312. When the air pusher 315 moves back in the first direction 91, the air pusher 315 releases the pushing force applied to the valve stick 51. Thus, the second resilient member 53 urges the air spigot 52 to block the right opening of the air tube 312 again so the air stops entering the air tube 312 through the right opening of the air tube 312. When the air pusher 315 continues moving in the first direction 91, the air pusher 315 loses contact with the sloping guide rail 37 and drops down to squeeze the air tube 315 again.

The airflow guiding member 32 includes a first airflow guiding tube 321 and a second airflow guiding tube 322 connected to the two ends of the air tube 312. The other ends of the first airflow guiding tube 321 and the second airflow guiding tube 322 are connected to the air channel selector 33. When the air pusher 315 moves in the first direction 91, the air pusher 315 pressures the air inside the air tube 312 into the first airflow guiding tube 321 and the airflow is introduced to the air channel selector 33 by the first airflow guiding tube 321. When the air pusher 315 moves in the second direction 92, the air pusher 315 pressures the air inside the air tube 312 into the second airflow guiding tube 322 and the airflow is introduced to the air channel selector 33 by the second airflow guiding tube 322.

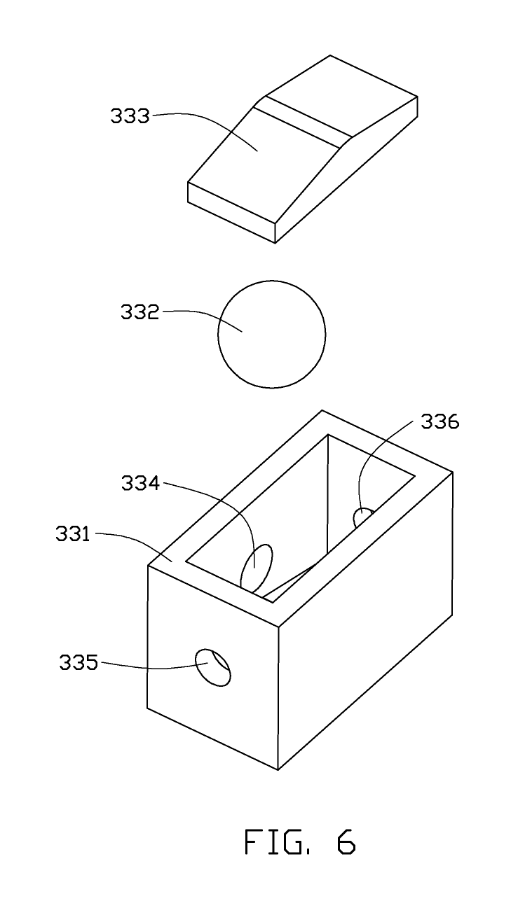

When the air pusher 315 moves in the first direction 91, the air channel selector 33 introduces the airflow into the first airflow splitter 34. When the air pusher 315 moves in the second direction 92, the air channel selector 33 introduces the airflow into the second airflow splitter 35. Referring to FIG. 6, the air channel selector 33 includes a box 331, a ball 332, and a cover 333. The ball 332 is received in the box 331 and is free to move within the box 331. The cover 333 is attached to the box 331 to prevent the ball 331 from escaping the box 331. The box 331 defines an air inlet 334 connected to the airflow guiding member 32, a first air outlet 335 connected to the first airflow splitter 34, and a second air outlet 336 connected to the second airflow splitter 35.

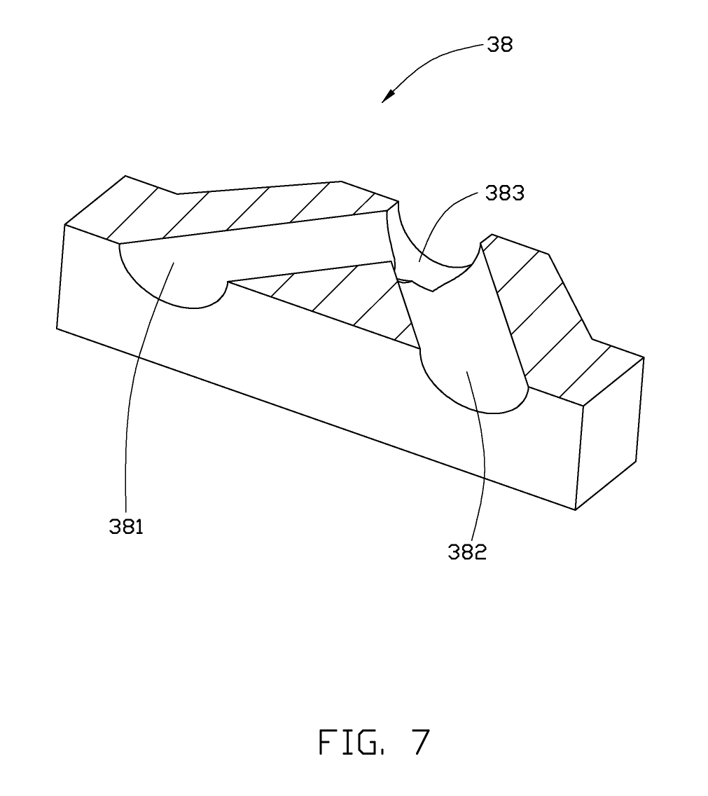

The inkjet printer further includes a tube fixing member 38. Referring to FIG. 7, the tube fixing member 38 defines a first airflow guiding channel 381 and a second airflow guiding channel 382. The first airflow guiding channel 381 and the second airflow guiding channel 382 form a substantially V-shaped angle and share a conjunct opening 383. The first airflow guiding channel 381 communicates with the first airflow guiding tube 321. The second airflow guiding channel 382 communicates with the second airflow guiding tube 322. The conjunct opening 383 communicates with the air inlet 334 of the box 331 of the air channel selector 33.

The air channel selector 33 is attached to the print-head carriage 10. When the print-head carriage 10 moves in the first direction 91 or in the second direction 92, the air channel selector 33 moves together with the print-head carriage 10.

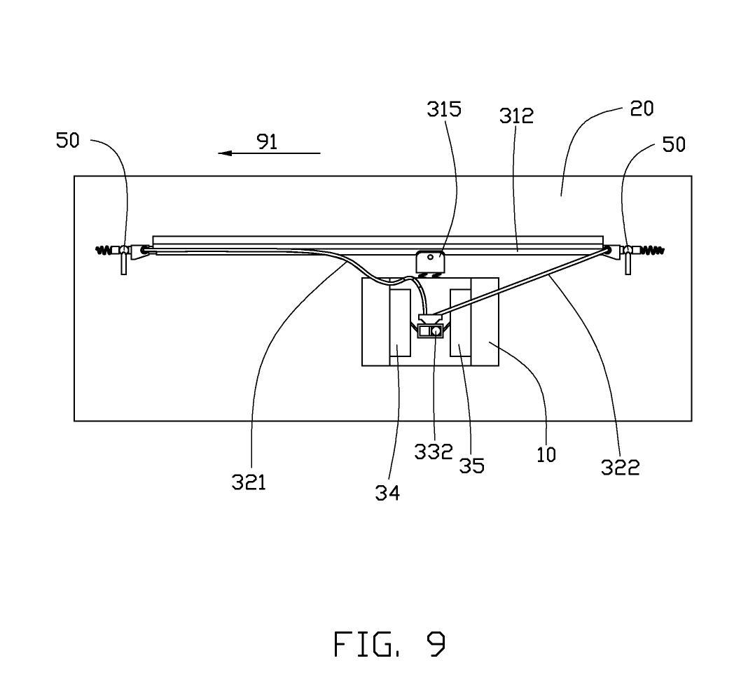

Referring to FIG. 9, when the print-head carriage 10 moves in the first direction 91 (to the left), the box 331 of the air channel selector 33 moves together with the print-head carriage 10 in the first direction 91. During the movement to the left of the air channel selector 33, the ball 332 moves in the second direction 92 and blocks the second air outlet 336 of the box 331 due to inertia. Thus, the airflow introduced into the air channel selector 33 can only exit out of the first air outlet 335 and be forced into the first airflow splitter 34. The first airflow splitter 34 splits the airflow into derivative airflow and introduces the derivative airflow into the first group of air channels 11. The derivative airflow passes through the first group of air channels 11 and is directed straight towards the print medium placed on the platform 20.

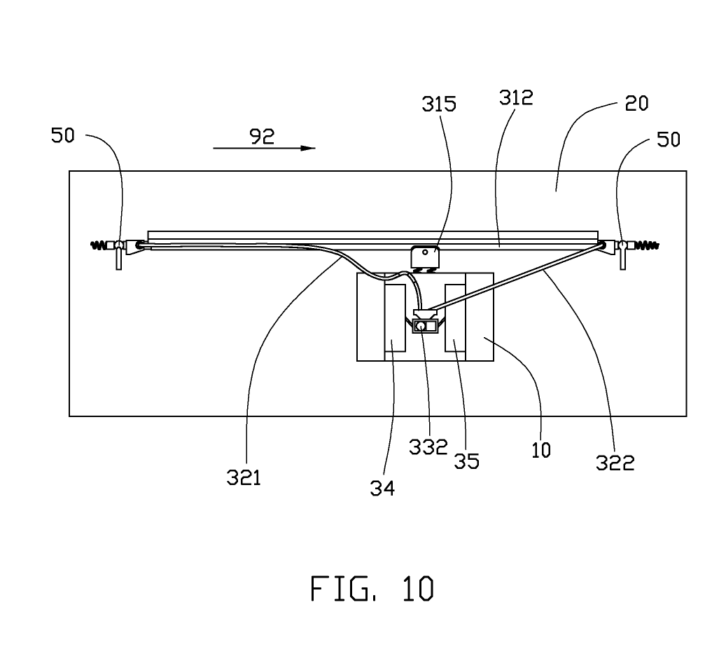

Referring to FIG. 10, when the print-head carriage 10 moves in the second direction 92 (to the right), the box 331 of the air channel selector 33 moves together with the print-head carriage 10 in the second direction 92. During the movement to the right of the air channel selector 33, the ball 332 moves in the second direction 92 and blocks the first air outlet 335 of the box 331 due to inertia. Thus, the airflow introduced into the air channel selector 33 can only exit out of the second air outlet 336 and be forced into the second airflow splitter 35. The second airflow splitter 35 splits the airflow into derivative airflow and introduces the derivative airflow into the second group of air channels 12. The derivative airflow passes through the second group of air channels 12 and is directed straight towards the print medium placed on the platform 20, ensuring that in any direction of movement of the print head, the print medium on the platform 20 is forced down, and therefore forced flat, onto the platform 20, resulting in the constant delivery of ink droplets to the print medium at an optimal distance from the print head.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An inkjet printer, comprising:
a platform for placing a print medium;
a print-head carriage defining a plurality of air channels, each of the plurality of air channels having an air intake and an air outtake, the air outtake being located on a bottom surface of the print-head and facing the platform; and
an airflow controller adapted to generate airflow and introduce the airflow into each of the plurality of air channels through the air intake, wherein the airflow is guided by the plurality of air channels and blows towards the platform though the air outtake.

2. The inkjet printer of claim 1, wherein the airflow controller comprises:
an airflow generator adapted to generate the airflow;
an airflow splitter; and
an airflow guiding member adapted to guide the airflow generated by the airflow generator to the airflow splitter;
wherein the airflow splitter is adapted to split the airflow into derivative airflow and introduce the derivative airflow into the plurality of air channels through the air intake.

3. The inkjet printer of claim 2, wherein the airflow generator comprises an air tube and an air pusher, when the air pusher presses the air tube and moves along the air tube, the air pusher deforms the air tube and extrudes air inside the air tube to generate the airflow.

4. The inkjet printer of claim 3, wherein the inkjet printer further comprises a first resilient member, one end of the first resilient is connected to the print-head carriage and the other end of the first resilient member is connected to the air pusher, and the first resilient member is adapted to produce an elastic force to push the air pusher to press the air tube.

5. The inkjet printer of claim 3, wherein the inkjet printer further comprises two air valves located at two respective openings of the air tube, and when the pusher moves to an opening of the air tube, the air valve located at the opening of the air tube opens.

6. The inkjet printer of claim 5, wherein the air valve comprises an air spigot and a second resilient member adapted to produce an elastic force to push the air spigot to block the opening of the air tube.

7. The inkjet printer of claim 6, wherein the air valve further comprises a valve stick, the air spigot is attached to an end of the valve stick, and the valve stick is adapted to drive the air spigot to move away from the opening of the air tube.

8. The inkjet printer of claim 7, wherein when the pusher moves to the opening of the air tube, the air pusher is adapted to push the valve stick to drive the air spigot to move away from the opening of the air tube.

9. The inkjet printer of claim 3, wherein the air guiding member comprises a first air guiding tube and a second air guiding tube, one end of the first guiding tube is connected to a first end of the air tube and the other end of the first guiding tube is connected to the airflow splitter, and one end of the second guiding tube is connected to the second end of the air tube and the other end of the second guiding tube is connected to the airflow splitter.

10. The inkjet printer of claim 9, wherein when the air pusher moves in a first direction along the air tube, the air pusher is adapted to drive the airflow to blow into the first air guiding tube and then into the airflow splitter; when the air pusher moves in a second direction opposite to the first second direction along the air tube, the air pusher is adapted to drive the airflow to blow into the second air guiding tube and then into the airflow splitter.

11. An inkjet printer, comprising:
a platform for placing a print medium;
a print-head carriage defining a plurality of air channels, each of the plurality of air channels having an air intake and an air outtake, the air outtake being located on a bottom surface of the print-head and facing the platform, wherein the plurality of air channels comprises a first group of air channels defined at a first side of the print-head carriage and a second group of air channels defined at a second side of the print-head carriage; and
an airflow controller adapted to generate airflow, to select one group of air channels of the first group of air channels and the second group of air channels, and to introduce the airflow into the selected group of air channels through the air intake, wherein the airflow is guided by the selected group of air channels and blows towards the platform though the air outtake.

12. The inkjet printer of claim 11, wherein the airflow controller comprises:
an airflow generator adapted to generate the airflow;
a first airflow splitter connected to the first group of air channels and adapted to split the airflow into derivative airflow and introduce the derivative airflow into the first group of air channels;
a second airflow splitter connected to the second group of air channels and adapted to split the airflow into derivative airflow and introduce the derivative airflow into the second group of air channels; and
an air channel selector adapted to select one airflow splitter of the first airflow splitter and the second airflow splitter, and introduce the airflow into the selected airflow splitter.

13. The inkjet printer of claim 12, wherein when the print-head carriage moves in a first direction, the air channel selector is adapted to select the first airflow splitter and introduce the airflow into the first airflow splitter, and when the print-head carriage moves in second direction opposite to the first direction, the air channel selector is adapted to select the second airflow splitter and introduce the airflow into the second airflow splitter.

14. The inkjet printer of claim 13, wherein the air channel selector comprises a box and a ball received in the box, the box defines an air inlet connected to the airflow guiding member, a first air outlet connected to the first airflow splitter, and a second air outlet connected to the second airflow splitter; when the print-head carriage moves in the first direction, the ball blocks the second air outlet; when the print-head carriage moves in the second direction, the ball blocks the first air outlet.

15. The inkjet printer of claim 13, wherein the airflow generator comprises an air tube and an air pusher, and when the air pusher presses the air tube and moves along the air tube, the air pusher deforms the air tube and extrudes air inside the air tube to generate the airflow.

16. The inkjet printer of claim 15, wherein the inkjet printer further comprises a first resilient member, one end of the first resilient is connected to the print-head carriage and the other end of the first resilient member is connected to the air pusher, and the first resilient member is adapted to produce an elastic force to push the air pusher to press the air tube.

17. The inkjet printer of claim 15, wherein the inkjet printer further comprises two air valves located at two respective openings of the air tube, and when the pusher moves to an opening of the air tube, the air valve located at the opening of the air tube opens.

18. The inkjet printer of claim 17, wherein the air valve comprises an air spigot and a second resilient member adapted to produce an elastic force to push the air spigot to block the opening of the air tube.

19. The inkjet printer of claim 18, wherein the air valve further comprises a valve stick, the air spigot is attached to an end of the valve stick, and the valve stick is adapted to drive the air spigot to move away from the opening of the air tube.

20. The inkjet printer of claim 19, wherein when the pusher moves to the opening of the air tube, the air pusher is adapted to push the valve stick to drive the air spigot to move away from the opening of the air tube.
